(19) United States
(12) Patent Application Publication
(10) Pub. No.: US 2026/0029234 A1
(43) Pub. Date: Jan. 29, 2026

(54) STAR MAP IDENTIFICATION METHOD BASED ON COMPOSITE CALIBRATION STAR GRID PATTERN

(71) Applicant: XI'AN INSTITUTE OF OPTICS AND PRECISION MECHANICS OF CAS, Xi'an (CN)

(72) Inventors: Meiying Liu, Xi'an (CN); Hu Wang, Xi'an (CN); Yaoke Xue, Xi'an (CN); Hui Zhao, Xi'an (CN); Shangmin Lin, Xi'an (CN); Yang Shen, Xi'an (CN)

(21) Appl. No.: 18/976,254

(22) Filed: Dec. 10, 2024

(30) Foreign Application Priority Data
Jul. 25, 2024 (CN) 202411004099.2

(51) Int. Cl. G01C 21/02

(52) U.S. Cl. CPC G01C 21/02

(57) ABSTRACT

A star map identification method based on a composite calibration star grid pattern is provided, which includes obtaining an observation star map, selecting a host star to be identified based on the observation star map; constructing the grid pattern features of the calibration star and performing comparison of a lookup table to obtain candidate matching results; obtaining candidate matching stars corresponding to the host star to be identified, carrying out validity verification of the initial matching results based on the FOV constraint, and filtering the candidate matching results through the calculation of angular distance and voting. The method based on the composite calibration star grid pattern uses the grid pattern as the matching pattern feature, by introducing multiple calibration star measurements, the stability of the characteristic pattern in construction is improved, and the influence of position noise and brightness noise inn the algorithm recognition process is reduced.

### CROSS-REFERENCE

This application claims to the benefit of priority from Chinese Application No. 202411004099.2 with a filing date of Jul. 25, 2024. The content of the aforementioned applications, including any intervening amendments thereto, are incorporated herein by reference.

### TECHNICAL FIELD

The present disclosure relates to the technical field of star sensor navigation, in particular to a star map identification method based on a composite calibration star grid pattern.

### BACKGROUND

Star sensors, also known as stellar sensors or star trackers, are high-precision space attitude measurement devices that use stars as reference frames and the starry sky as the working object. It provides accurate spatial orientation and reference for aerospace vehicles such as satellites and spacecraft by detecting stars at different positions on the celestial sphere and performing calculations. Star sensors not only have autonomous navigation capabilities, but also play important roles in multiple application scenarios such as navigation, mission planning, positioning, and orbit control.

For star sensors, star map identification is a crucial algorithm, and its attitude accuracy also depends on it. The star map identification algorithm requires obtaining the position and brightness information of star points in the captured star map, so weak targets in the captured space within the field of view will also participate in star map identification. With the continuous development of technology, star map identification algorithms are becoming increasingly mature, and the application of star sensors is becoming more and more common. In current, the widely used star map identification algorithms includes pattern recognition algorithms and subgraph isomorphism algorithms, wherein the pattern recognition algorithms include grid algorithms, radial and circumferential algorithms. The grid pattern construction process requires the selection of calibration star, usually the closest observation star is selected, and then the reference line of the grid is clearly divided. However, due to the interference such as noise and pseudo stars, errors may occur in the selection of calibration star, resulting in the failure to recognize the patterns to be identified; the radial mode of the radial pattern algorithms only describes the distribution characteristics of neighboring stars in the radial direction, which means that the representation of neighboring stars is not comprehensive enough; the circumferential pattern is easily disturbed by noise in the construction process, which leads to wrong mode coding. The subgraph isomorphism algorithms include triangle algorithm, pyramid algorithm, and group matching method. Among them, the triangle algorithm has a simple principle, but the effective dimensionality of the feature subgraph is too low, and the positioning accuracy of detecting star points is limited; the pyramid algorithm will make too errors in selection of star points during the construction phase of feature subgraphs, resulting in significant time consumption; and the group matching method may not obtain accurate identification results due to the limitation of brightness, noise and the database construction.

### SUMMARY

In view of this, the present disclosure proposes a star map identification method based on a composite calibration star grid pattern to solve the problems existing in the existing technology.

To achieve the above objectives, the present disclosure proposes a star map identification method based on the composite calibration star grid pattern, including:
Obtaining an observation star map and selecting a plurality of navigation stars based on the observation star map;
Obtaining the observation star map and selecting the host star to be identified;
Performing an initial identification, selecting three neighboring stars as composite calibration stars, and sequentially constructing grid pattern features for each of calibration stars, comparing lookup tables based on grid characteristic patterns;
Obtaining a similarity count, if the pattern matching process meets a similarity threshold, obtaining a candidate matching result, otherwise, selecting a next calibration star to carry out a grid pattern construction and matching, and constructing an initial matching result based on the grid pattern construction and matching;
Carrying out a validity verification on the initial matching results based on the FOV constraint principle.

Optionally, a process of selecting the host star to be identified based on the observation star map includes:
Selecting a star catalogue with appropriate limiting magnitude and position error as a basic star catalogue for constructing the navigation database, using the magnitude threshold method to exclude variable stars and double stars from the basic star catalogue, and using the remaining stars as navigation stars.

Optionally, a process of constructing the grid characteristic patterns of all navigation stars includes:
Constructing a neighboring star set for the star to be identified in the observation star map;
Moving the star to be identified and selecting calibration stars simultaneously;
Taking the connecting line between the star to be identified and the calibration star as a reference line, rotating the observation star map to the X-axis direction of the reference line;
Dividing a detector plane into g×g uniform grids;
Assigning values to elements in the uniform grids and obtaining grid pattern features between the star to be identified and the calibration stars respectively, and constructing the grid characteristic patterns based on the grid pattern features.

Optionally, a process of moving the star to be identified and selecting the calibration stars simultaneously includes:

Moving the star to be identified to a center of the observation star map, obtaining the angular distance values between the neighboring stars in the neighboring star set and the star to be identified, and taking the three observation stars with the closest angular distance values to the star to be identified as the composite calibration stars.

Optionally, a process of assigning values to elements in the uniform grids and obtaining the grid characteristic patterns between the star to be identified and the calibration stars includes:

If there is at least one observation star point in the uniform grids, assigning value corresponding element to 1, otherwise, assigning value to 0, recording the assigned element with one-dimensional vector, and obtaining the grid pattern features of three calibration stars based on the assignment and recording results.

Optionally, a process of constructing a grid characteristic pattern lookup table based on the grid characteristic patterns includes:
Obtaining numbers of the navigation stars, obtaining the grid pattern features corresponding to the navigation stars based on the numbers, obtaining positions where the elements of the navigation stars are assigned values of 1 in uniform grids based on the grid pattern features, then storing the navigation stars in the positions where the elements are assigned values of 1, traversing the grid pattern features of the navigation stars in the entire observation star map until all grid pattern features are stored in their positions, and the grid characteristic pattern lookup table is constructed.

Optionally, the grid characteristic pattern lookup table comprises a guide star catalogue and a grid characteristic pattern database, the guide star catalogue is used to store data information of all navigation stars for right ascension, number, and declination, and the grid characteristic pattern database is used to store the grid characteristic patterns of all navigation stars.

Optionally, a process of obtaining candidate navigation stars for the to be identified based on the grid characteristic pattern lookup table includes:
Assigning counter groups to all navigation stars and setting a value of each of counters to 0;
If there are an elements assigned values of 1 in the grid characteristic patterns of the star to be identified, obtaining the corresponding navigation stars stored in the grid characteristic pattern lookup table, and adding 1 to the values of counters corresponding navigation stars;
After traversing the elements in the grid characteristic patterns of the star to be identified, obtaining a counter with the highest value in the counter groups, and constructing a pattern matching threshold, if a value of the counter with the highest value is not less than the pattern matching threshold, it is considered a successful match, and selecting the navigation star corresponding to the counter with the highest value as a candidate navigation star.

Optionally, in a process of constructing the initial matching result based on the candidate navigation stars, if the navigation star corresponding to the star to be identified is unique, a first candidate navigation star successfully matched is taken as an initial matching result, if the navigation star corresponding to the star to be identified is not unique, all candidate navigation stars successfully matched are taken as the initial matching result.

Optionally, a process of carrying out a validity verification on the candidate navigation stars based on the FOV constraint principle includes:
Step 1: obtaining a first distance between the stars to be observed and a second distance between the candidate navigation stars, constructing a deviation threshold, and if the deviation between the first distance and the second distance is less than the deviation threshold, adding 1 to values of counters of the corresponding candidate navigation stars; and
Step 2: repeating step 1 until all stars to be observed have completed traversal, constructing a verification threshold, considering candidate navigation stars with values of the counters not less than the verification threshold as successful verification, and candidate navigation stars with values of the counters less than the verification threshold as failed verification.

Compared with the existing technology, the advantageous effects of the present disclosure are:

The star map identification method based on the composite calibration star grid pattern provided by the present disclosure uses the grid pattern as the matching pattern feature, by introducing multiple calibration star measurements, the stability of the characteristic pattern in construction is improved, and the influence of position noise and brightness noise inn the algorithm recognition process is reduced; subsequently, FOV constraint is adopted to screen for the maximal cluster, carrying out a validity verification on initial identification results. The method described in the present disclosure is capable of achieving effective identification of +10.5 Mv star maps

### BRIEF DESCRIPTION OF THE DRAWINGS

By reading the detailed description of the preferred embodiments in the following text, various other advantages and benefits will become clear to those skilled in the art. The accompanying drawings are only for the purpose of illustrating preferred embodiments and should not to be considered as limitations of the present disclosure. In the accompanying drawings:

FIG. 1 is a flow diagram of a star map identification method based on a composite calibration star grid pattern in an embodiment of the present disclosure;

FIG. 2 is a functional diagram of the grid characteristic pattern lookup table in an embodiment of the present disclosure;

FIG. 3 is a diagram of the initial matching and verification process in an embodiment of the present disclosure.

### DETAILED DESCRIPTION OF THE EMBODIMENTS

The exemplary embodiments of the present disclosure will be described in more detail below with reference to the accompanying drawings. Although exemplary embodiments of the present disclosure are shown in the accompanying drawings, it should be understood that the present disclosure may be implemented in various forms and should not be limited by the embodiments described herein. On the contrary, these embodiments are provided to enable a more thorough understanding of this disclosure and to fully convey the scope of this disclosure to those skilled in the art. It should be noted that the embodiments and features in the embodiments of the present disclosure can be combined with each other without conflict. The present disclosure will be described in detail below with reference to the accompanying drawings and in conjunction with embodiments.

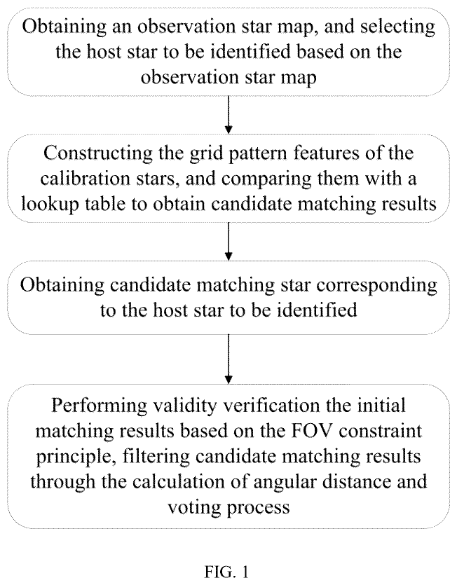

This embodiment proposes a star map identification method based on a composite calibration star grid pattern, as shown in FIG. 1, which includes the following steps:
Obtaining an observation star map and selecting a plurality of navigation stars based on the observation star map;
Constructing grid characteristic patterns for all navigation stars and constructing a grid characteristic pattern lookup table based on the grid characteristic pattern;
Obtaining the host star to be identified, obtaining candidate navigation stars for the host star to be identified based on the grid characteristic pattern lookup table, and constructing initial matching results based on the candidate navigation stars;
Carrying out a validity verification on the initial matching results based on the FOV constraint principle.

The all celestial sphere autonomous star map identification algorithm based on improved grid pattern of the disclosure mainly includes two parts, namely the initial identification step based on the grid pattern and the candidate matching star verification step based on FOV constraints. The initial identification process adopts a grid pattern matching strategy, utilizing the similarity of grid features to quickly obtain candidate navigation stars corresponding to the observation stars, thereby narrowing down the scope of matching verification; the verification step is based on the field of view constraint criterion, using angular distance features to select the maximum cluster from candidate navigation stars, and outputting it as the final identification result of the star map identification algorithm. The following will explain the relevant composite calibration star grid patterns within the algorithm, followed by a detailed introduction to the construction of the navigation star database. Finally, the steps of all celestial sphere autonomous star map identification algorithm based on improved grid pattern will be described in detail.

The construction of the grid pattern of the present disclosure is similar to the ordinary Padgett grid algorithm, mainly modifying the selection criteria for the calibration stars, the nearest three neighboring stars are used as the pattern to construct calibration stars, and corresponding grid characteristic patterns are constructed for them. The specific steps of pattern construction are as follows:
Step 1: taking the observation stars whose angular distance from the host star in the field of view is within the range of r-pr as the neighboring star, thereby forming a neighboring star set;
Step 2: moving the host star to the center of the observation star map, and selecting the three observation stars closest to the angular distance values of the host star in the neighboring star set as calibration stars;
Step 3: setting the reference line as the connecting line between the host star and the first calibration star, and rotating the observation star map until the reference line is in the horizontal direction; on this basis, dividing the detector plane into g×g uniform grids;
Step 4: assigning values to the elements in the g×g grid, defining cell as the element located at (i, j) in the grid. If there is at least one observation star point in the grid, setting the corresponding element cell (i, j) to 1, otherwise, setting the cell (i, j) value to 0. Here, carrying out one-dimensional characterization on grid elements to obtain the grid pattern characteristics of the host star corresponding to the first calibration star;
Step 5: taking the connecting line between the host star and the second calibration star as the reference line, repeating steps 3 and 4 to construct the grid pattern features of the host star corresponding to the second calibration star; similarly, constructing the grid pattern features of the host star corresponding to the third calibration star.

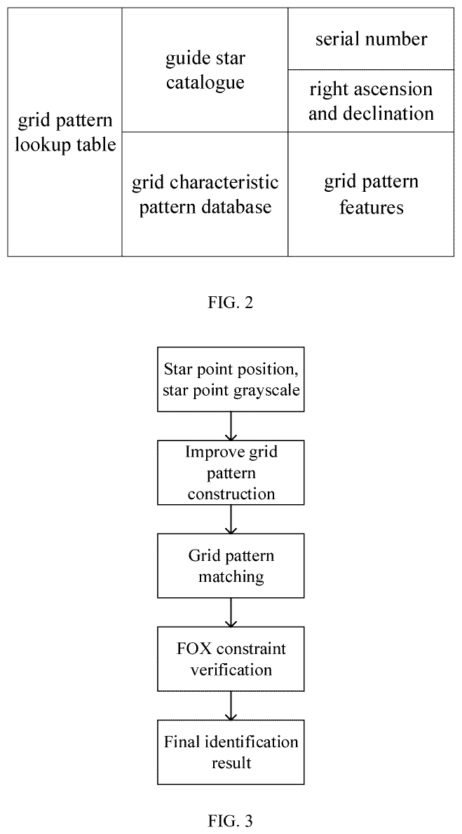

The basic basis for star map matching in the all celestial sphere star map identification algorithm is the grid characteristic pattern lookup table, which mainly consists of two parts: the pattern database and the guide star catalogue (FIG. 2). Among them, the guide star catalogue mainly stores the data information of navigation stars for right ascension, number, and declination, while the pattern database mainly stores the characteristic patterns related to navigation stars. Taking the star map identification algorithm proposed in the present disclosure as an example, the pattern database includes the grid pattern features corresponding to all navigation stars. The process of constructing a grid characteristic pattern lookup table can be summarized into the following two steps: (1) selecting suitable stars as navigation stars within the all celestial sphere; (2) constructing grid patterns corresponding to all navigation stars, and storing relevant data in a certain structure.

Selection of the navigation stars:
At present, the most commonly used star catalogues include Tycho catalogue, SAO catalogue, Tycho2 catalogue, Hipparcos catalogue, HST guide star catalogue, Gaia catalogue, etc. The SAO catalogue is the most widely used fundamental table in starlight navigation, with high measurement accuracy and a position error of 1″, which can meet the needs of starlight navigation to a certain extent. However, the present disclosure is aimed at the task of identifying, tracking and positioning weak targets in the all celestial sphere with a limiting magnitude of +10.5 Mv. The main stars included in the SAO catalogue have a brightness of about 8.0 Mv, and the records of stars with higher magnitude are not complete, which can not be used as the basis for subsequent star exclusion. Here, the present disclosure uses the Tycho-2J2000 star catalogue as the basic star catalogue for constructing a navigation database, which records in detail the position, brightness, and other information of stars with magnitudes <11 Mv. Assuming the field of view of the observation camera is 2°×2° and the limiting magnitude is +10.5 Mv, theoretically all stars in the catalog with brightness higher than +10.5 Mv can be imaged. Based on this, using the magnitude threshold method and excluding variable stars and double stars from the Tycho-2J2000 catalog, the remaining stars are used as navigation stars.

### Construction and Storage of Characteristic Pattern:

After determining the navigation stars, traversing all navigation stars in sequence and constructing a grid pattern for each navigation star. After the grid pattern construction is completed, the present disclosure stores it according to the lookup table, wherein the data structure of the lookup table mainly considers the real-time performance of the grid pattern matching process, which is illustrated by the following examples.

Assuming the navigation star number is #256 and its corresponding grid pattern features have element values of 1 at positions 36, 58, 66, 90, and 96 of the matrix, storing the navigation star number #256 in rows 36, 58, 66, 90, and 96 of the lookup table. Traversing the all grid patterns of the navigation stars until all grid patterns are stored using the above method to complete the construction of the grid characteristic pattern lookup table.

The main framework of the star map identification algorithm based on the composite calibration star grid pattern includes an initial identification part and a FOV verification part. The initial identification process uses an improved grid pattern to obtain candidate navigation stars corresponding to the observation stars. However, due to factors such as noise or missing fields of view, the matching in the initial identification results may be incorrect. In practical tasks, the consequences of incorrect matching are unacceptable. Therefore, in the follow-up of the algorithm needs to design a filtering step to effectively verify the candidate navigation star identification results in the initial matching stage, filter out incorrect matches, and search for the correct initial matching results, which will be used as the final matching result of the star map identification algorithm.

### Initial Identification Steps:

As shown in FIG. 3, the initial identification step selects the observation star to be identified as the c*a star closest to the center of the field of view (c≥1), and sequentially constructs its corresponding grid pattern. If the grid pattern matching of the first calibration star can meet the matching threshold, then the matching result is the candidate navigation star; on the contrary, if the matching result cannot meet the threshold, construct a grid pattern for the second calibration star for matching; similarly, the same strategy should be adopted for the construction and matching of the third calibration star. The design considerations for the initial identification stage of the algorithm in the present disclosure are as follows: improving the grid pattern as a reliable discrimination criterion for matching the distribution characteristics of the host star and neighboring stars. The more calibration stars selected, the stronger the robustness of the pattern construction process, but the real-time performance of the algorithm will be reduced. Therefore, it should be reasonable to choose the number of calibration stars, so that the initial identification process meets has both requirements of reliable matching and running speed. Next, the matching process is illustrated by an example:

Assuming that the grid pattern of a certain observation star to be identified can be represented as (21, 27, 32, 69, 88, 128), according to the grid characteristic pattern lookup table, the reference star numbers corresponding to rows 21, 27, . . . , and 128 in the grid characteristic pattern lookup table are searched separately. The statistical results show that number 256 appears 6 times and the remaining numbers appear 1 time. The pattern matching process is summarized as follows:

In the initial stage, completing the counter initialization, that is, assign counter groups to all N navigation stars, i.e. (CT₁CT₂CT₃, . . . . CT_{N}), and the counter corresponding to navigation star i is CTᵢ, and the counter is set to 0. If the k-th element of the grid pattern corresponding to the observation star to be identified is 1, then search for the navigation star stored in the i-th row of the grid characteristic pattern lookup table and add 1 to the counter value corresponding to the navigation star number. After traversing all elements in the grid pattern, select the maximum numerical counter from the counter group (CT₁CT₂CT₃, . . . . CT_{N}). If its corresponding score is not less than the pattern matching threshold min_mat in the algorithm, the navigation star to which the counter belongs is the candidate navigation star; if its score is less than min_mat, it is considered that the matching relationship between the observation star and the corresponding navigation star is not considered to be valid. If the navigation star corresponding to the star to be identified is unique, it will be considered as a candidate navigation star, which is the initial matching result of the observation star; if the navigation star corresponding to the star to be identified is not unique, record all matching results and further use verification methods to screen them. The significance of initial matching is to narrow down the search matching range of the all celestial sphere to a set of several candidate navigation stars for quick verification.

### FOV Constraint Verification:

After the initial identification is completed, the candidate navigation stars corresponding to the observation stars have been determined. However, there may be some incorrect matching star pairs in the initial identification results. Therefore, the present disclosure proposes a verification strategy using angular distance voting to screen the initial matching results, exclude possible mismatched candidate navigation stars, and achieve fast and effective verification of the initial matching results. The specific idea of the algorithm is as follows:

Assuming the distance between observation points s₁ and s₂ is d^{s}₁₂, and the candidate navigation stars corresponding to s₁ and s₂ in the initial matching stage are G₁ and G₂, respectively, with a distance of d^{G}₁₂. During the angular distance voting process, if the deviation between d^{s}₁₂ and d^{G}₁₂ is less than the threshold ε, s₁ and s₂ will receive votes from G₁ and G₂, respectively, adding 1 to the corresponding counter. Repeat the above steps until all star pairs of observation stars have completed traversal.

According to the FOV constraint principle, correctly matched candidate navigation stars are all located in the field of view, and they support each other in the voting process, so the corresponding counter value is larger, while the wrongly matched candidate navigation stars get fewer votes and the corresponding counter value is smaller. Therefore, the correct number of matching star pairs in the initial matching process is selected based on the angular distance voting results. If the counter value of the candidate matching star pairs is higher than the validation threshold ver_min, it means that the verification is successful, and the final identification result is the matching relationship; on the contrary, it it means that the verification failed.

Unless otherwise specified, all technical and scientific terms used in this article have the same meanings as those commonly understood by those skilled in the art of the present disclosure. Although the present disclosure only describes preferred methods and materials, any methods and materials similar or equivalent to those described herein may also be used in the implementation or testing of the present disclosure. All references mentioned in this specification are incorporated by reference to disclose and describe methods and/or materials related to the mentioned references. In case of conflict with any incorporated references, the content of this specification shall prevail. Finally, it should be noted that the above embodiments are only the detailed description of the embodiments of the present disclosure, used to illustrate the technical solution of the present disclosure, and not to limit it. The protection scope of the present disclosure is not limited to this. Although the present disclosure has been described in detail with reference to the above embodiments, ordinary skilled in the art should understand that any skilled familiar with the technical field can still modify or easily think of changes to the technical solution described in the above embodiments, or equivalently replace some of the technical features within the technical scope disclosed in the present disclosure. However, these modifications, changes or substitutions do not make the essence of the corresponding technical solution deviate from the spirit and scope of the technical solution of the embodiments of the present disclosure. All should be covered within the scope of the present disclosure. Therefore, the scope of the present disclosure should be based on the scope of the claims.

1. A star map identification method based on a composite calibration star grid pattern, comprising following steps:
obtaining an observation star map and selecting a plurality of navigation stars based on the observation star map;
obtaining the observation star map and selecting the host star to be identified;
performing an initial identification, selecting three neighboring stars as composite calibration stars, and sequentially constructing grid pattern features for each of calibration stars, comparing lookup tables based on grid characteristic patterns;
obtaining a similarity count, if the pattern matching process meets a similarity threshold, obtaining a candidate matching result, otherwise, selecting a next calibration star to carry out a grid pattern construction and matching, and constructing an initial matching result based on the grid pattern construction and matching;
carrying out a validity verification on the initial matching result based on the FOV constraint principle.

2. The star map identification method based on the composite calibration star grid pattern according to claim 1, wherein a process of selecting the host star to be identified based on the observation star map comprises:
selecting a star catalogue with appropriate limiting magnitude and position error as a basic star catalogue for constructing the navigation database, using the magnitude threshold method to exclude variable stars and double stars from the basic star catalogue, and using the remaining stars as navigation stars.

3. The star map identification method based on the composite calibration star grid pattern according to claim 1, wherein a process of constructing the grid characteristic patterns of all navigation stars comprises:
constructing a neighboring star set for the star to be identified in the observation star map;
moving the star to be identified and selecting the calibration star simultaneously;
taking a connecting line between the star to be identified and the calibration star as a reference line, rotating the observation star map to a X-axis direction of the reference line;
dividing a detector plane into g×g uniform grids;
assigning values to elements in the uniform grids and obtaining grid pattern features between the star to be identified and the calibration stars respectively, and constructing the grid characteristic patterns based on the grid pattern features.

4. The star map identification method based on the composite calibration star grid pattern according to claim 3, wherein a process of moving the star to be identified and selecting the calibration star simultaneously comprises:
moving the star to be identified to a center of the observation star map, obtaining angular distance values between the neighboring stars in the neighboring star set and the star to be identified, and taking three observation stars with a closest angular distance values to the star to be identified as the composite calibration stars.

5. The star map identification method based on the composite calibration star grid pattern according to claim 3, wherein a process of assigning values to elements in the uniform grids and obtaining the grid characteristic patterns between the star to be identified and the calibration stars comprises:
if there is at least one observation star point in the uniform grids, assigning value corresponding element to 1, otherwise, assigning value to 0, recording the assigned element with one-dimensional vector, and obtaining the grid pattern features of three calibration stars based on the assignment and recording results.

6. The star map identification method based on the composite calibration star grid pattern according to claim 1, wherein a process of constructing a grid characteristic pattern lookup table based on the grid characteristic patterns comprises:
obtaining numbers of the navigation stars, obtaining the grid pattern features corresponding to the navigation stars based on the numbers, obtaining positions where the elements of the navigation stars are assigned values of 1 in uniform grids based on the grid pattern features, then storing the navigation stars in the positions where the elements are assigned values of 1, traversing the grid pattern features of the navigation stars in the entire observation star map until all grid pattern features are stored in their positions, and the grid characteristic pattern lookup table is constructed.

7. The star map identification method based on the composite calibration star grid pattern according to claim 1, wherein the grid characteristic pattern lookup table comprises a guide star catalogue and a grid characteristic pattern database, the guide star catalogue is used to store data information of all navigation stars for right ascension, number, and declination, and the grid characteristic pattern database is used to store the grid characteristic patterns of all navigation stars.

8. The star map identification method based on the composite calibration star grid pattern according to claim 1, wherein a process of obtaining candidate navigation stars for the to be identified based on the grid characteristic pattern lookup table comprises:
assigning counter groups to all navigation stars and setting a value of each of counters to 0;
if there are an elements assigned values of 1 in the grid characteristic patterns of the star to be identified, obtaining the corresponding navigation stars stored in the grid characteristic pattern lookup table, and adding 1 to the values of counters corresponding navigation stars;
after traversing the elements in the grid characteristic patterns of the star to be identified, obtaining a counter with the highest value in the counter groups, and constructing a pattern matching threshold, if a value of the counter with the highest value is not less than the pattern matching threshold, it is considered a successful match, and selecting the navigation star corresponding to the counter with the highest value as a candidate navigation star.

9. The star map identification method based on the composite calibration star grid pattern according to claim 1, wherein, in a process of constructing the initial matching result based on the candidate navigation stars, if the navigation star corresponding to the star to be identified is unique, a first candidate navigation star successfully matched is taken as an initial matching result, if the navigation star corresponding to the star to be identified is not unique, all candidate navigation stars successfully matched are taken as the initial matching result.

10. The star map identification method based on the composite calibration star grid pattern according to claim 1, wherein a process of carrying out a validity verification on the candidate navigation stars based on the FOV constraint principle comprises:
step 1: obtaining a first distance between the stars to be observed and a second distance between the candidate navigation stars, constructing a deviation threshold, and if a deviation between the first distance and the second distance is less than the deviation threshold, adding 1 to values of counters of the corresponding candidate navigation stars; and
step 2: repeating step 1 until all stars to be observed have completed traversal, constructing a verification threshold, considering candidate navigation stars with values of the counters not less than the verification threshold as successful verification, and candidate navigation stars with values of the counters less than the verification threshold as failed verification.
